(19) United States
(12) Patent Application Publication
(10) Pub. No.: US 2006/0126354 A1
(43) Pub. Date: Jun. 15, 2006

(54) Automobile led light

(76) Inventor: Kuan-Chih Fu, Tainan City (TW)

Correspondence Address: Kuan-Chih Fu, P.O. Box 90, Tainan City, 70499, TW

(21) Appl. No.: 11/011,175

(22) Filed: Dec. 15, 2004

(30) Foreign Application Priority Data
Dec. 9, 2004 (TW) 093219811

(51) Int. Cl. F21S 8/10

(52) U.S. Cl. 362/545

(57) ABSTRACT

An automobile LED light includes a base, a circuit board, a plurality of LED, and a cap. The base has plural fitting posts to fit with holes formed in the circuit board to combine the circuit board in its interior. The circuit board is made of an insulating board and an aluminum plate superposed on the insulating board, so the circuit board is possible to be cut into any shape by means of pressing owing to the comparatively good extensibility of the aluminum plate. Then a plurality of conductive copper foil lines are fixed on a lower surface of the insulating board for connecting electrically the pins of the LED inserted through the circuit board. So the circuit board can be applied to different types of automobile lights.

### BACKGROUND OF THE INVENTION

1. Field of the Invention

This invention relates to an automobile LED (light emitting diode) light, particularly to one easily assembled together and including a base, a circuit board possible to be processed by pressing and a cap conveniently closed on the base. The circuit board is made of an insulating board and an aluminum plate superposed on the insulating board to enable the circuit board easily processed by pressing for matching with different shapes of an automobile light.

2. Description of the Prior Art

A conventional automobile light shown in FIGS. 1, 2 and 3 includes a base 10, plural circuit boards 11 and a cap 12. The base 10 is provided with many symmetrical threaded posts 100 and inner circumferential fitting ridges 101. The plural circuit boards 11 is fixed in the base 10 with screws, made of an insulating board 110, having plural copper foil lines 111 fixed on the lower surface, plural LED 112 positioned on the upper side, a threaded hole 112 respectively in two sides of each circuit board 11. Then a wire is connected with each circuit board 11. The cap 12 is closed on the base 10, having projecting ridges 120 on an inner circumferential surface to fit with the fitting ridges 101 of the base 10.

However, the conventional automobile LED light has the circuit boards 11 respectively made of an insulating board 110 and plural foil lines 111. As the insulating board 110 is hard and fragile, it is rather difficult to be cut by pressing process. In addition, there are many circuit boards 11 to be combined with the insulating board 110 with screws (N), taking much time. Besides, each circuit board 11 needs a wire 114 for connecting the LED on it, so many wires 114 intercross with each other; it makes up much difficulty in case of repairing or replacing components.

### SUMMARY OF THE INVENTION

The purpose of the invention is to offer an automobile LED light, which has a circuit board possible to be cut into different shapes by means of pressing process for matching with different types of automobile lights and easily assembled.

The main feature of the invention is a circuit board made of an insulating board with an aluminum plate superposed on the insulating board to enable the circuit board cut into any shape by means of pressing process owing to the comparatively good extensibility of the aluminum plate.

### BRIEF DESCRIPTION OF DRAWINGS

This invention will be better understood by referring to the accompanying drawings, wherein:

FIG. 1 is an exploded perspective view of a conventional automobile LED light;

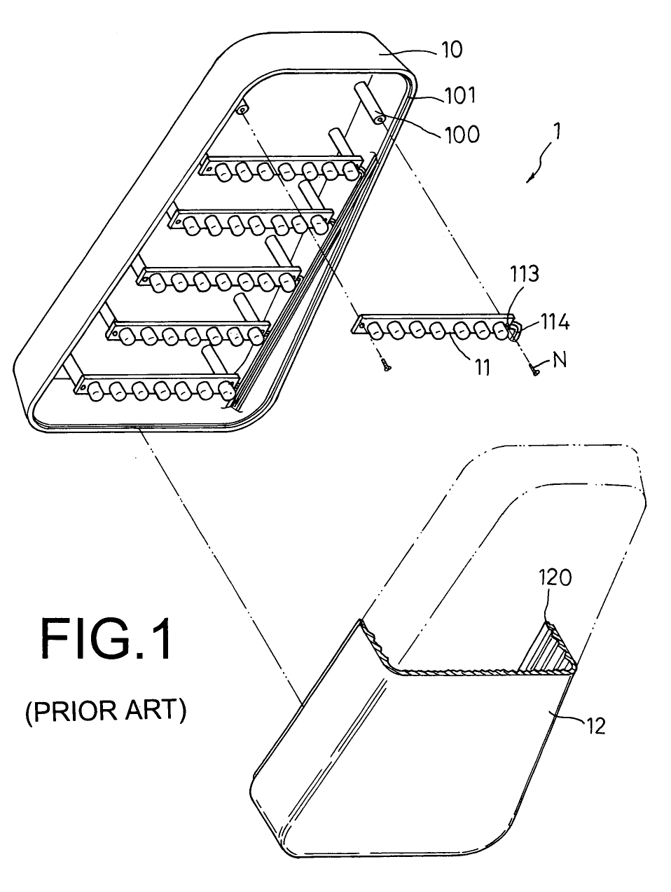

FIG. 2 is a perspective view of a circuit board in the conventional automobile LED light;

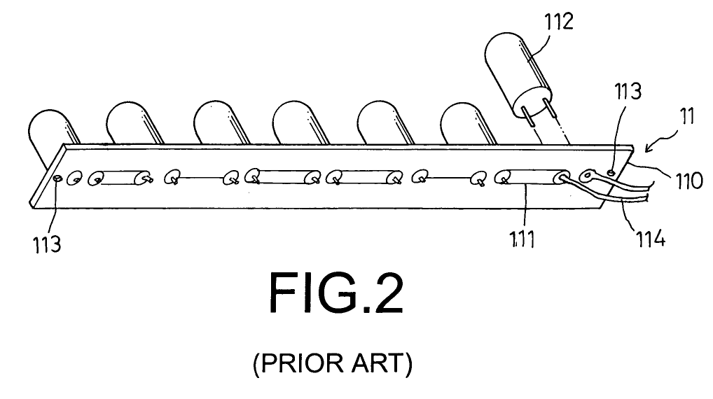

FIG. 3 is a cross-sectional view of the circuit board in the conventional automobile LED light;

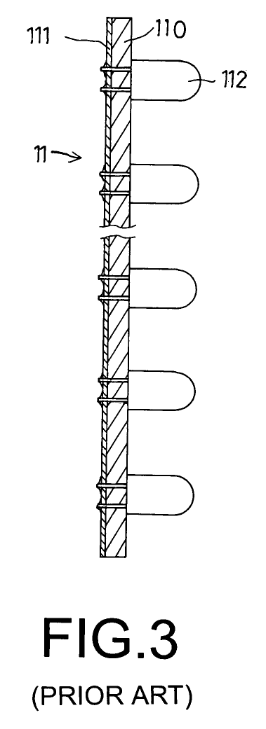

FIG. 4 is an exploded perspective view of an automobile LED light in the present invention;

FIG. 5 is a cross-sectional view of a circuit board in the automobile LED light in the present invention; and,

FIG. 6 is a perspective view of a shape of the circuit board possible to be cut in the present invention.

### DETAILED DESCRIPTION OF THE PREFERRED EMBODIMENT

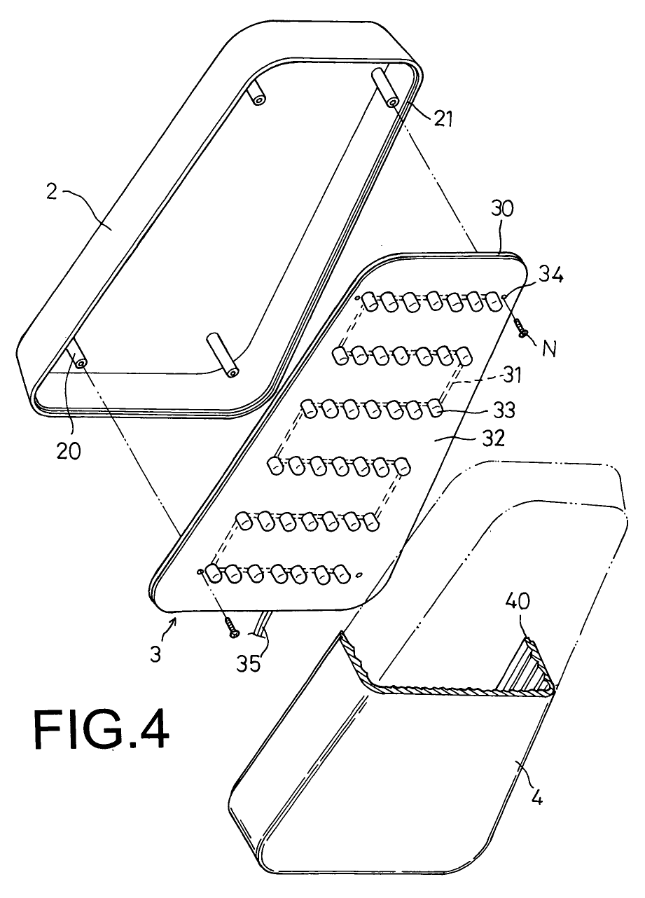

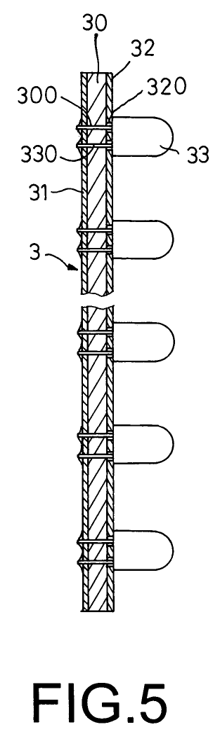

A preferred embodiment of an automobile LED light in the present invention, as shown in FIGS. 4 and 5, includes a base 2, a circuit board 3, a plurality of LED (light emitting diodes) 33 and a cap 4 as main components.

The base 2 has a circumferential low wall, a plurality of fitting posts 20 symmetrically positioned on an inner surface and a fitting ridges formed on an inner circumferential surface.

The circuit board 3 is positioned in the base 2, made of an insulating board 30 and an aluminum plate 32 superposed on the insulating board 30, a plurality of conductive copper foil lines 31 fixed regularly on a lower surface, many insert holes 300 in the insulating board 30, many holes 320 in the aluminum plate 32 corresponding respectively to the insert holes 300 of the insulating board 30. Further, the circuit board 3 is connected with a wire 35.

The LED 33 are respectively positioned regularly on the circuit board 3, with each pair of the pins 330 of each LED 33 inserting in the holes of the aluminum plate 320 and the insert holes 300 of the insulating board 30 and then welded with each copper foil line 31. Then the circuit board 3 is combined with the base 2 by the fitting posts 20 fitting in holes 34 of the circuit board 3.

The cap 4 is closed on the base 2, having circumferential ridges 40 in an inner circumferential surface to fit with the fitting ridges 21 of the base 2.

In assembling, referring to FIGS. 4 and 5, the circuit board 3 is positioned in the base 2, with the fitting posts 20 of the base 2 fitting firmly in the holes 34 of the circuit board 3, and then the cap 4 is closed on the base 2, with the projecting ridges 40 fitting with the fitting ridges 21 of the base 2, finishing the assembly of the automobile LED light in the invention.

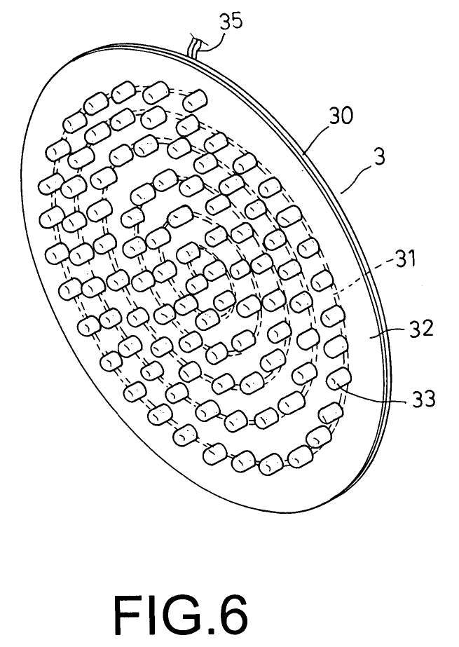

As the aluminum plate 32 has a comparatively good extensibility to endure pressing process, the circuit board 3 is capable to be cut into any shape by means of pressing process, as a shape shown in FIG. 6 for matching with different types of automobile lights.

Moreover, the combining method of the holes 34 of the circuit board 3 with the fitting posts 20 can be replaced by combination of threaded holes and threaded posts for screws (N) to screw, or by glues, or projecting posts and projecting points welded together, Any one of these method can be used for combination of these components.

The invention has the following advantages, as can be understood from the foresaid description.

1. The circuit board can be shaped by means of pressing process owing to the additional provision of the aluminum plate possessing comparatively good extensibility, for matching with different types of automobile lights.

2. Pressing formation of the circuit board can speed up its production.

While the preferred embodiment of the invention has been described above, it will be recognized and understood that various modifications may be made therein and the appended claims are intended to cover all such modifications that may fall within the spirit ad scope of the invention.

What is claimed is:

1. An automobile LED light comprising:
a base provided with a plurality of fitting posts;
a circuit board positioned in said base and made of an insulating board and a plurality of conductive copper foil lines fixed regularly on a lower surface of said insulating board;
a plurality of LED positioned on an upper surface of said insulating board, each said LED having pins inserted through said insulating board and connected electrically with each said copper foil line;
a cap closed on said base; and,
characteristics that said circuit board has an aluminum plate superposed on said insulating board, said aluminum plate having a comparatively good extensibility to enable said circuit board cut into any shape by means of pressing process for matching with different types of automobile lights.

2. The automobile LED light as claimed in claim 1, wherein said base is provided with circumferential insert ridges on an inner circumferential surface.

3. The automobile LED light as claimed in claim 1, wherein said cap is provided with circumferential ridges to fit with said insert ridges of said base for combining said cap with said base.

4. The automobile LED light as claimed in claim 1, wherein said circuit board is provided with holes for said fitting posts to fit with for combining said base with said circuit board.
